(19) United States
(12) Patent Application Publication
(10) Pub. No.: US 2017/0005938 A1
(43) Pub. Date: Jan. 5, 2017

(54) SYSTEM AND METHOD OF TCP/IP BYPASS OVER UNIVERSAL SERIAL BUS (USB)

(71) Applicant: KONICA MINOLTA LABORATORY U.S.A., INC., San Mateo, CA (US)

(72) Inventor: Carlos RIMOLA, Campbell, CA (US)

(73) Assignee: KONICA MINOLTA LABORATORY U.S.A., INC., San Mateo, CA (US)

(21) Appl. No.: 14/755,524

(22) Filed: Jun. 30, 2015

(51) Int. Cl. H04L 12/801; H04L 29/08

(52) U.S. Cl. CPC H04L 47/19; H04L 67/02

(57) ABSTRACT

A method and system are disclosed for implementing a TCP/IP bypass over Universal Serial Bus (USB), including receiving USB data on an IPP-USB proxy through a kernel USB driver; sending the USB data from the IPP-USB proxy to an HTTP server as an IPP request encapsulated in an HTTP request; receiving the HTTP and IPP requests on the HTTP server and routing the IPP request directly to an IPP service module for processing of the IPP request; processing the IPP request on the IPP Service module and issuing an IPP response which is routed directly to the HTTP Server; transmitting the IPP response encapsulated in an HTTP response from the HTTP Server to the IPP-USB proxy; writing the received HTTP and IPP responses from the HTTP Server to the kernel USB driver; and transmitting the IPP response over an USB interface using the USB protocol to a client device.

### FIELD OF THE INVENTION

The present disclosure relates a method and system for avoiding the use of TCP/IP (or internet protocol suite) and processing overhead associated with TCP/IP when used over Universal Serial Bus (USB), which can guarantee the orderly and integral delivery of data like network traffic, and therefore does not need to utilize TCP/IP.

### BACKGROUND OF THE INVENTION

Networks have enhanced our ability to communicate and access information by allowing one personal computer to communicate over a network (or network connection) with another personal computer and/or other networking devices, using electronic messages. When transferring an electronic message between personal computers or networking devices, the electronic message will often pass through a protocol stack that performs operations on the data within the electronic message (e.g., packetizing, routing, flow control).

TCP/IP is the universal protocol used to encapsulate network traffic over the Internet as well as personal and corporate network packets. Other widely used protocols such as HTTP, used for Web client/server communication, FTP, used for file transfers, and just about every other Internet protocol require TCP/IP. One of the reasons for this is that IP, the lower level protocol, is routable and has minimal overhead traversing routers from point A to point B. A “point” here should be understood to be a “host,” for example, be it a computer, a mobile device, any device with an IP address. IP is practically always used together with TCP because IP is a datagram protocol, which does not guarantee delivery of the packets it encapsulates.

TCP comes into play in the networks described above since TCP has sophisticated algorithms that guarantee delivery and data integrity from point A to point B. IP alone does not provide these guarantees and is subject to data (packet) loss. The design of TCP allows it to guarantee delivery over the most unreliable mediums, including those with high packets loss and lack of data integrity. However, the benefits afforded by TCP and it associated algorithms are well known to be costly and consume a significant amount of processing power.

In accordance with an exemplary embodiment, method and system including a TCP/IP bypass is disclosed, which can help eliminate the use of TCP when the media over which the communication takes place guarantees data integrity and orderly delivery, eliminating the need for TCP/IP and its associated overhead. In the present disclosure, the specific reliable media to which it applies is the Universal Serial Bus (USB), which provides orderly and integral, guaranteed delivery of data sent and received.

### SUMMARY OF THE INVENTION

In consideration of the above issues, it would be desirable to have a software module or software application associated with a computer device or host device such as an Multi-Function Peripheral (MFP), which facilitates TCP/IP bypass over Universal Serial Bus (USB), which can, for example, enhance printing capabilities of the MFP by reducing and/or eliminating the installation of necessary software applications and/or printer drivers on the client devices.

In accordance with an exemplary embodiment, the software module or proxy can be introduced with existing/working components, and which can operate over a TCP/IP Network Interface having an Operating System (OS) or Kernel USB Driver, a HTTP Server, and an IPP Server. In addition, the software application or proxy can accomplish the TCP/IP bypass over Universal Serial Bus (USB) by acting as a bridge, and using the Loopback (internal) Interface and the standard Sockets API on a host device as disclosed herein.

A method is disclosed of implementing a TCP/IP bypass over Universal Serial Bus (USB), the method comprising: receiving USB data on an IPP-USB proxy through a kernel USB driver; sending the USB data from the IPP-USB proxy to an HTTP server as an IPP request encapsulated in an HTTP request; receiving the HTTP and IPP requests on the HTTP server and routing the IPP request directly to an IPP service module for processing of the IPP request; processing the IPP request on the IPP Service module and issuing an IPP response which is routed directly to the HTTP Server; transmitting the IPP response encapsulated in an HTTP response from the HTTP Server to the IPP-USB proxy; writing the received HTTP and IPP responses from the HTTP Server to the kernel USB driver; and transmitting the IPP response over an USB interface using a USB protocol to a client device.

A non-transitory computer readable medium is disclosed containing a computer program having computer readable code embodied to carry out a method of implementing a TCP/IP bypass over Universal Serial Bus (USB), the method comprising: receiving USB data on an IPP-USB proxy through a kernel USB driver; sending the USB data from the IPP-USB proxy to an HTTP server as an IPP request encapsulated in an HTTP request; receiving the HTTP and IPP request on the HTTP server and routing the IPP request directly to an IPP service module for processing of the IPP request; processing the IPP request on the IPP Service module and issuing an IPP response which is routed directly to the HTTP Server; transmitting the IPP response encapsulated in an HTTP response from the HTTP Server to the IPP-USB proxy; writing the received HTTP and IPP responses by the IPP-USB proxy to the kernel USB driver; and transmitting the IPP response over an USB interface using a USB protocol to a client device.

A system is disclosed for implementing a TCP/IP bypass over Universal Serial Bus (USB), the system comprising: a USB connection; a client device configured to send USB data; and a host device connected to the client device via the USB connection, the host device having a kernel USB driver, an IPP-USB proxy, an HTTP server, and a IPP service module, and wherein the host device is configured to: receive the USB data on an IPP-USB proxy through the kernel USB driver; send the request USB data from the IPP-USB proxy to the HTTP server as an HTTP+IPP request; receive the HTTP+IPP request on the HTTP server and routing the IPP request directly to the IPP service module for processing of the IPP request; process the IPP request on the IPP Service module and issuing an IPP response which is routed directly to the HTTP Server; transmit the HTTP+IPP response from the HTTP Server to the IPP-USB proxy; write the received HTTP+IPP response by the IPP-USB proxy to the kernel USB driver; and transmit the HTTP+IPP response over the USB connection to the client device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system having TCP/IP bypass in accordance with an exemplary embodiment.

FIG. 2 is a flow chart showing an implementation of a TCP/IP bypass in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

This disclosure relates to a system and method of implementation of an exemplary application of TCP/IP Bypass over Universal Serial Bus (USB). For example, in accordance with an exemplary embodiment, the method as disclosed herein can be an implementation of “IPP over USB,” also known as “IPP-USB” (Internet Printing Protocol-Universal Serial Bus).

The IPP-USB method of communication between an IPP Client and an IPP Server is defined in the “USB Print Interface Class IPP Protocol Specification” dated Dec. 5, 2012. The Specification defines a method of transmitting HTTP+IPP request and responses over USB, which requires no TCP/IP encapsulation.

In accordance with an exemplary embodiment, a system and method for implementation and support for IPP-USB is disclosed using an application or proxy that reads and writes HTTP+IPP data (requests/responses) directly from USB and uses an internal TCP/IP loopback interface using the standard sockets API and interfaces to pass the HTTP+IPP data to existing HTTP and IPP servers. In addition, the system and method as disclosed can have minimal impact on the HTTP and IPP servers since the requests are received and processed as if they had arrived via a standard network interface (using the standard Sockets API and layer). In addition, responses can be handled in a similar way in the reverse direction.

IPP-USB is a protocol used to communicate with a printer using IPP and HTTP over a USB connection. Normally, printers that communicate using IPP do so over the network and the encapsulation of a packet is as follows:

IPP
HTTP
TCP
IP

The encapsulation is from top to bottom. That is, IPP is encapsulated in HTTP, HTTP is encapsulated in TCP and TCP is encapsulated in IP.

In IPP-USB, the TCP and IP layers are dropped so the encapsulation is simplified as follows:

IPP
HTTP

What makes this simplification possible is that USB, unlike other forms of connectivity like Ethernet or Wi-Fi, is a direct point to point connection that can guarantee integrity and orderly delivery of data and packet transfers. Since both HTTP and IPP can be normally transmitted over traditional network media like Ethernet and Wi-Fi, TCP/IP can be required because TCP/IP provides guaranteed delivery (data integrity) and can traverse networks (for example, TCP/IP can be routable). TCP/IP also provides the convenience of an API for client/server communication, “The Socket layer API.”

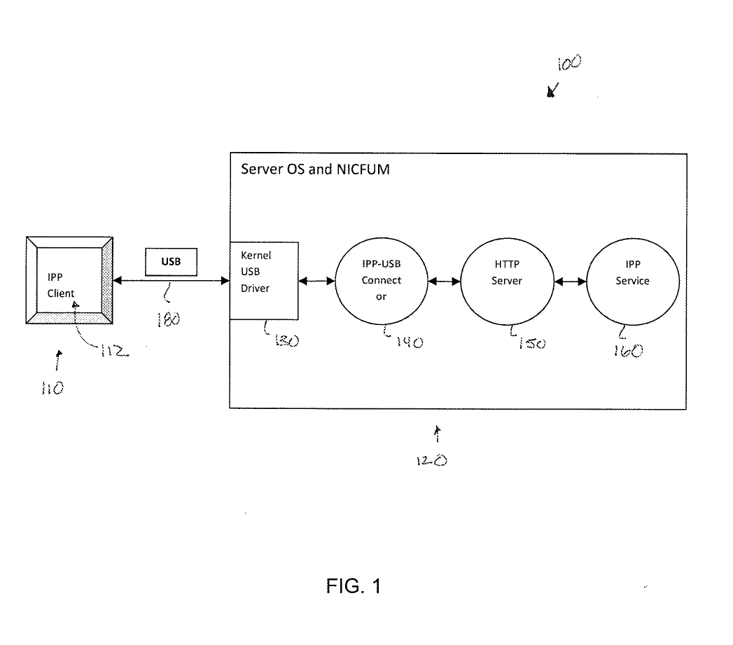

FIG. 1 illustrates a system 100 having TCP/IP bypass in accordance with an exemplary embodiment. As shown in FIG. 1, a system 100 is illustrated, which can include at least one client device 110, a host device 120, and a USB connection 180 connecting the at least one client device 110 and the host device 120. For example, the USB connection 180 can be a wire or USB cable without encryption or authentication.

In accordance with an exemplary embodiment, the at least one client device 110 is preferably an IPP client 112, for example, a PC running Mac OS, Window, Linux or any OS that contains an IPP-USB Client. The client device 110 can include a processor or central processing unit (CPU), and one or more memories for storing software programs and data (such as files to be printed). The processor or CPU carries out the instructions of a computer program, which operates and/or controls at least a portion of the functionality of the at least one client device 110.

As set forth above, the client device 110 includes an operating system (OS), which manages the computer hardware and provides common services for efficient execution of various software programs. The software programs can include, for example, application software and printer driver software. For example, the printer driver software controls a multifunction printer or printer, for example, the host device 120 connected with the client device 110 in which the printer driver software is installed. In certain embodiments, the printer driver software can produce a print job and/or document based on an image and/or document data. In addition, the printer driver software can control transmission of the print job from the client device 110 to the host device 120, for example, in the form of a multifunction printer or printer.

In accordance with an exemplary embodiment, the host device 120 may be embodied by a printer, a Multi-Functional Peripheral (MFP), an image forming apparatus and other known apparatuses, which prints an image on a printing medium (or a recording medium) such as a sheet of paper based on printing data generated by the at least one client device 110. In accordance with an exemplary embodiment, the host device 120 is a Multi-Functional Peripheral (MFP), which can include at least a copy function, an image reading function, and a printer function, and forms an image on a sheet based on a print job (print instruction) sent from at least one second host (the client device) 110, image data read by an image reading section, such as a scanner, provided in the host device (or image forming apparatus) 120, or the like.

The host device 120 can be a Multi-Functional Peripheral (MFP). The host device 120, for example, as designated in FIG. 1 as “Server OS and NICFUM,” can represent an MFP with NICFUM representing the implementation of the MFP software functionality. As shown in FIG. 1, the host device 120 includes a Kernel USB Driver 130, an IPP-USB proxy or module 140, an HTTP server 150, and an IPP service module 160. In accordance with an exemplary embodiment, the IPP-USB proxy or module 140 can perform the functionality necessary to make IPP-USB support transparent to the HTTP Server 150 and the IPP Service module 160, which can require little or no modification to these components.

The host device 120 in the form of a MFP can include a printer controller (or firmware), a memory section preferably in the form of a hard disk drive (HDD), an image processing section (or data dispatcher), a print engine, and an input/output (I/O) section. The controller of the host device 120 can include a central processing unit (CPU), a random access memory (RAM), and a read only memory (ROM). The central processing unit can be configured to execute a sequence of stored instructions (for example, a computer program). The controller can include an operating system (OS), which acts as an intermediary between the software programs and hardware components within the host device 120. The operating system (OS) manages the computer hardware and provides common services for efficient execution of various application software. In accordance with an exemplary embodiment, the controller processes the data and job information received from the client device 110 and generates a print image.

The image processing section carries out image processing under the control of the controller, and sends the processed print image data to the print engine. The image processing section is preferably capable of processing multiple print jobs or sub-jobs in parallel and independently. For example, the image processing section can include a CPU that contains multiple cores therein to realize the multiple raster image processor (RIP) modules explained in detail later. The CPU used constituting a part of the controller can be commonly used for the image processing section. The print engine forms an image on a recording sheet based on the image data sent from the image processing section. The I/O section performs data transfer with the at least one client device 110. The controller can be programmed to process data and control various other components of the multifunction printer or printer to carry out the various methods described herein. The hard disk drive (HDD) or storage device stores digital data and/or software programs for recall by the controller. In accordance with an exemplary embodiment, the digital data includes resources, which can include graphics/images, logos, form overlays, fonts, etc.

Examples of a host device 120 in the form of a Multi-Functional Peripheral (MFP) or image forming apparatus consistent with exemplary embodiments include, but are not limited to, a laser beam printer (LBP), a multifunction laser beam printer including copy function, an ink jet printer (IJP), a thermal printer (for example, a dye sublimation printer) and a silver halide printer. For example, the MFP or image forming apparatus can be a color printer or a black and white (B/W) printer.

In accordance with an embodiment, the at least one client device 110, which may be embodied by a computer system, and generates the printing data usable in the host device 120 and transmits the generated printing data to the host device 120. The host device 120 and the at least one client device 110 can constitute an image forming system to install a communication port, to generate printing data, and to perform a printing operation of forming an image on a printing medium according to the printing data.

In accordance with an exemplary embodiment, the at least one client device 110 can be a plurality of personal computers, and can have the function of sending a print job to the host device 120 in the form of a multifunction printer (MFP) or an image forming apparatus. A printer driver program (hereinafter, sometimes simply referred to as a printer driver) is installed in the at least one client device 110, and the at least one client device 110 can use the function of the printer driver to generate a print job including the data of print conditions to be applied at the time of image formation, image data, and the like, and to send the generated print job to the host device 120 in the form of a multifunction printer.

A system and method is disclosed of implementation of IPP-USB in an embedded environment running a multi-tasking Operating System like Linux without using TCP/IP. For example, in accordance with an exemplary embodiment, the at least one client device 110 and the host device 120 can be directly connected via the USB connection 180.

In accordance with an exemplary embodiment, the system and method as disclosed for the implementation of a TCP/IP bypass over Universal Serial Bus (USB), can include an IPP-USB proxy 140, which can be a module or proxy, which can transparently interconnect IPP-USB data sent and received between the kernel USB driver 130 and the HTTP server 150. The HTTP server 150 directly routes the IPP requests to the IPP service 160. Similarly, in the reverse direction, IPP responses can be handled by the HTTP server 150 and sent to the IPP-USB proxy 140, which transmits the response over USB using the kernel USB driver. The use of Operating System and kernel are synonymous with one another as set forth herein.

In accordance with an exemplary embodiment, the IPP-USB proxy 140 can be configured to meet IPP-USB specifications, which can include utilization of certified USB devices, conforms with the USB Common Class Specification 1.0, conforms with the USB Print Interface class specification 1.1, implements 2 Print Class Interfaces that advertise protocol 4 as one of the USB interface options and provide a device info class-specific descriptor, and implements a single IPP Service. In addition, the IPP-USB proxy 140 can be configured such that each print class interface can provide protocol 4 as an alternate, which must connect to the single printer IPP service, and can reject HTTP 1.0 requests with HTTP 505 error code.

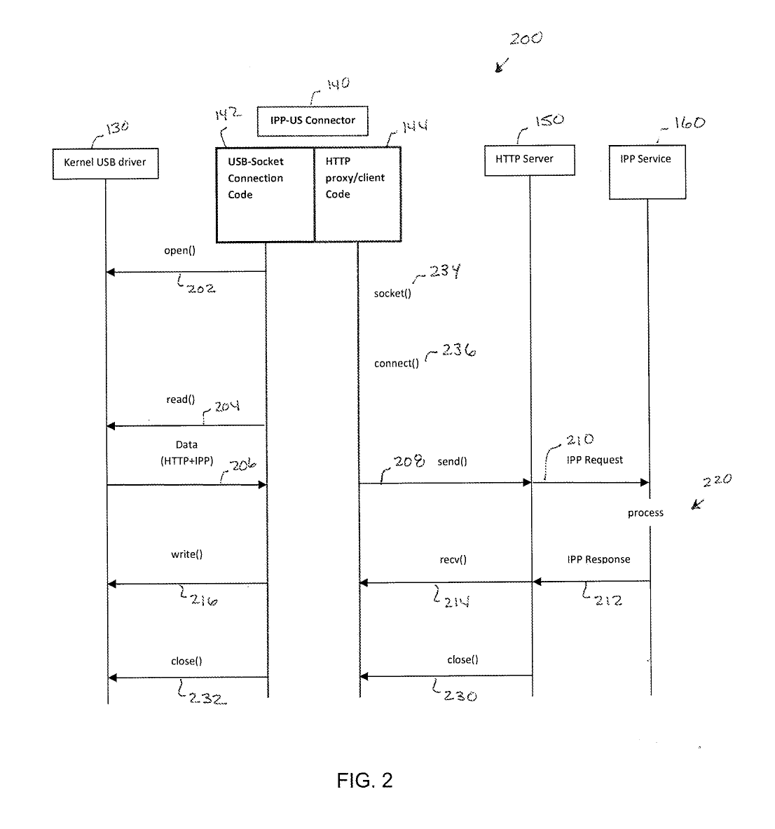

FIG. 2 is a flow chart showing an implementation of a TCP/IP bypass in accordance with an exemplary embodiment. As illustrated in FIG. 2, the IPP-USB proxy 140 can be configured to include two main components, which can be implemented as tasks, for example, as a USB-Task module 142 and a Socket task module 144. In accordance with an exemplary embodiment, the USB-task module 142, preferably one per USB interface, can be responsible for receiving USB data, which can be, for example, an HTTP+IPP request, which is received directly from the USB interface.

In accordance with an exemplary embodiment, the USB-task module 142 routes the HTTP+IPP requests to the HTTP server 150. When the USB-task module 142 initializes, the USB-task module 142 opens the USB interface using, for example, a standard file I/O function 202, 204. For example, the standard file I/O function can be open( ) 202 and read( ) 204. In accordance with an exemplary embodiment, for example, the USB-Task module 142 can first open the USB interface and performs a read( ) function call 204, which will block until the IPP-USB client 110 writes data 206 to the USB interface 130. Once the data 206 is received, for example, as an HTTP+IPP request, the data 206 is passed to the HTTP server 150 via the IPP-USB proxy 140 using the sockets API send( ) function call 208 as an IPP request. The IPP request is then received by the HTTP server 150. The entire transfer from IPP-USB proxy 140 to HTTP server is performed via a local (loopback) interface 220.

In accordance with an exemplary embodiment, the socket task module 144, which is a component of the IPP-USB proxy 140, preferably one per USB interface, can be responsible for receiving the HTTP+IPP responses using the sockets API recv( ) function call 214. This is a blocking call, which can suspend the task until data 206 is received over the socket in use. Upon receiving the response, the socket task module 144 issues a file I/O write( ) function call 216 to the kernel USB driver 130, which proceeds to put the data on the wire on the USB interface using USB protocol methods.

In accordance with an exemplary embodiment, the HTTP server 150 can be responsible for forwarding the IPP requests 210 to the IPP server 160 directly. In accordance with an exemplary embodiment, this functionality can already exist and can be applied, for example, to IPP requests received over standard network interfaces. In accordance with an exemplary embodiment, since the request (HTTP+IPP request) 210 arrives via the local/loopback interface 220, the request 210 can be transparent to the HTTP server 150. For example, the HTTP+IPP requests 210 and responses 212 can be handled in the same way as those sent and received over standard network interfaces.

In accordance with an exemplary embodiment, the host device 120 can be configured to receive USB data (requests) through the Kernel USB driver 130 using, for example, the standard read( ) file I/O API. As shown in FIG. 2, for example, the IPP-USB proxy 140 sends the requests to the HTTP Server using the standard send( ) socket API function 212. The HTTP Server 150 uses the standard recv( ) socket API function 218 to receive the data and routes the IPP request 214 directly to the IPP Service 160, which processes the request 214. The IPP Service 160 processes the request 214 and issues an IPP response 216, which is routed directly to the HTTP server 150. The HTTP server 150 can use the standard socket send( ) function 208 to transmit the response, just as it would for a standard network interface. The IPP-USB proxy 140 can be waiting for the response via the socket recv( ) function 214. The response received by the IPP-USB proxy 140 is written to the USB interface via the USB Driver using a standard file I/O write( ) function call 216. The kernel USB device driver 130 receives the response data and transmits the response data directly over the USB interface. In accordance with an exemplary embodiment, once the exchange of data between the client device 110 and the host device 120 is completed, the APIs for the local (loopback) interface 220, and the connection between the kernel USB driver 130 and the IPP-USB proxy 140 can be closed (close( ) 230, 232. As shown in FIG. 2, the sockets API can also include socket( ) 234, which acquires a unique socket ID, and connect( ) 236, which establishes a connection with the HTTP server.

In accordance with an exemplary embodiment, for example, the media can be a USB connection 180, and, for example, the client device 110 and the host device 120 are connected via the USB connection 180. In accordance with an exemplary embodiment, the client device 110 can be a USB host device, for example, a PC (personal computer) running an operating system, for example, Mac OS, Windows or Linux with an IPP Client capable of sending HTTP+IPP data directly over USB.

In accordance with an exemplary embodiment, the system and method as disclosed can also be applied to other mediums, which meet the specifications of guaranteed delivery of data transmitted from point to point. For example, in accordance with an exemplary embodiment, the medium is configured such that no data is lost in transmission, and wherein the integrity of the data transmitted over the medium can be guaranteed. For example, in accordance with an exemplary embodiment, the data should arrive exactly as it was delivered, and wherein a guaranteed “in-order” (sequential) delivery of data transmitted is required, for example, where every octet arrives in the order in which it was transmitted.

In accordance with an exemplary embodiment, a non-transitory computer readable medium containing a computer program having computer readable code embodied to carry out a method of implementing a TCP/IP bypass over Universal Serial Bus (USB), the method comprising: receiving USB data on an IPP-USB proxy through a kernel USB driver; sending the USB data from the IPP-USB proxy to an HTTP server as an IPP request encapsulated in an HTTP request; receiving the HTTP and IPP request on the HTTP server and routing the IPP request directly to an IPP service module for processing of the IPP request; processing the IPP request on the IPP Service module and issuing an IPP response which is routed directly to the HTTP Server; transmitting the IPP response encapsulated in an HTTP response from the HTTP Server to the IPP-USB proxy; writing the received HTTP and IPP responses by the IPP-USB proxy to the kernel USB driver; and transmitting the IPP response over an USB interface using USB protocol to a client device.

The computer readable recording medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of implementing a TCP/IP bypass over Universal Serial Bus (USB), the method comprising:
receiving USB data on an IPP-USB proxy through a kernel USB driver;
sending the USB data from the IPP-USB proxy to an HTTP server as an IPP request encapsulated in an HTTP request;
receiving the HTTP and IPP requests on the HTTP server and routing the IPP request directly to an IPP service module for processing of the IPP request;
processing the IPP request on the IPP Service module and issuing an IPP response which is routed directly to the HTTP Server;
transmitting the IPP response encapsulated in an HTTP response from the HTTP Server to the IPP-USB proxy;
writing the received HTTP and IPP responses from the HTTP Server to the kernel USB driver; and
transmitting the IPP response over an USB interface using a USB protocol to a client device.

2. The method of claim 1, comprising:
receiving the USB data received first by the USB driver and then via a read(0 function call using a standard file I/O application programming interface (API); and
sending the USB data from the IPP-USB proxy to the HTTP server using a send( ) socket API function call.

3. The method of claim 2, comprising:
receiving the HTTP and IPP request on the HTTP server via a socket recv( ) API function call on the HTTP server.

4. The method of claim 1, comprising:
transmitting the response from the HTTP Server to the IPP-USB proxy via the socket send( ) API function call issued by the HTTP server;
receiving the response on the IPP-USB proxy via a socket recv( ) function; and
writing the received response from the HTTP Server to the USB interface via the USB Driver using a standard file I/O write( ) function call.

5. The method of claim 1, comprising:
receiving the USB data from the client device, the client device configured to send the USB data as an HTTP+IPP request.

6. The method of claim 5, wherein the client device is a personal computer running an Operating System (OS) containing an IPP-USB client.

7. The method of claim 6, comprising:
hosting the IPP-USB proxy on a host device, wherein the host device is a Multi-Functional Peripheral (MFP); and
processing print data that follows the HTTP+IPP request.

8. A non-transitory computer readable medium containing a computer program having computer readable code embodied to carry out a method of implementing a TCP/IP bypass over Universal Serial Bus (USB), the method comprising:
receiving USB data on an IPP-USB proxy through a kernel USB driver;
sending the USB data from the IPP-USB proxy to an HTTP server as an IPP request encapsulated in an HTTP request;
receiving the HTTP and IPP request on the HTTP server and routing the IPP request directly to an IPP service module for processing of the IPP request;
processing the IPP request on the IPP Service module and issuing an IPP response which is routed directly to the HTTP Server;
transmitting the IPP response encapsulated in an HTTP response from the HTTP Server to the IPP-USB proxy;
writing the received HTTP and IPP responses by the IPP-USB proxy to the kernel USB driver; and
transmitting the IPP response over an USB interface using USB protocol to a client device.

9. The computer readable medium of claim 8, comprising:
receiving the USB data received first by the USB driver and then using a standard file I/O API read( ) function call; and
sending the USB data in the form of the HTTP+IPP request from the IPP-USB proxy to the HTTP server using a send( ) socket API function call.

10. The computer readable medium of claim 9, comprising:
receiving the HTTP and IPP request on the HTTP server via a socket recv( ) API function call on the HTTP server.

11. The computer readable medium of claim 8, comprising:
transmitting the response from the HTTP Server to the IPP-USB proxy via the socket API send( ) function by the HTTP server;
receiving the response on the IPP-USB proxy via a socket API recv( ) function call; and
writing the received response from the HTTP Server to the USB interface via the USB Driver using a standard file I/O API write( ) function call.

12. The computer readable medium of claim 8, comprising:
receiving the USB data from the client device, the client device configured to send the USB data as an HTTP+IPP request.

13. The computer readable medium of claim 12, wherein the client device is a personal computer running an Operating System (OS) containing an IPP-USB client.

14. The computer readable medium of claim 13, comprising:
hosting the IPP-USB proxy on a host device, and wherein the host device is a Multi-Functional Peripheral (MFP); and
processing print data that follows the HTTP+IPP request.

15. A system for implementing a TCP/IP bypass over Universal Serial Bus (USB), the system comprising:
a USB connection;
a client device configured to send USB data; and
a host device connected to the client device via the USB connection, the host device having a kernel USB driver, an IPP-USB proxy, an HTTP server, and an IPP service module, and wherein the host device is configured to:
receive the USB data on an IPP-USB proxy through the kernel USB driver;
send the request USB data from the IPP-USB proxy to the HTTP server as an HTTP+IPP request;
receive the HTTP+IPP request on the HTTP server and routing the IPP request directly to the IPP service module for processing of the IPP request;
process the IPP request on the IPP Service module and issuing an IPP response which is routed directly to the HTTP Server;
transmit the HTTP+IPP response from the HTTP Server to the IPP-USB proxy;
write the received HTTP+IPP response by the IPP-USB proxy to the kernel USB driver; and
transmit the HTTP+IPP response over the USB connection to the client device.

16. The system of claim 15, wherein the host device is configured to:
receive the USB data received via a read( ) file I/O API function call issued by the IPP-USB proxy; and
send the USB data from the IPP-USB proxy to the HTTP server using a send( ) socket API function call.

17. The system of claim 16, wherein the host device is configured to:
receive the HTTP+IPP request on the HTTP server via a socket recv( ) API function call on the HTTP server; and
pass the IPP request from the HTTP server directly to the IPP service;
process the IPP request by the IPP service and pass the IPP response directly to the HTTP server;
receive the HTTP+IPP response on the IPP-USB proxy via a socket API recv( ) function call; and
write the received HTTP+IPP response by the IPP-USB proxy to the USB interface via the USB Driver using a standard file I/O write( ) function call.

18. The system of claim 15, wherein the host device is configured to:
receive the USB data from the client device, the client device configured to send the USB data as an HTTP+IPP request.

19. The system of claim 18, wherein the client device is a personal computer running an Operating System (OS) containing an IPP-USB client.

20. The system of claim 19, wherein hosting the USB-IPP proxy is hosted on a host device, the host device being a Multi-Functional Peripheral (MFP); and
processing the HTTP+IPP response on the host containing the IPP-USB client.
